(19) United States
(12) Patent Application Publication
(10) Pub. No.: US 2022/0339790 A1
(43) Pub. Date: Oct. 27, 2022

(54) ROBOT CALIBRATION

(71) Applicant: Divergent Technologies, Inc., Los Angeles, CA (US)

(72) Inventor: Richard Kingston, Los Angeles, CA (US)

(21) Appl. No.: 17/728,288

(22) Filed: Apr. 25, 2022

Related U.S. Application Data
(60) Provisional application No. 63/178,669, filed on Apr. 23, 2021.

(51) Int. Cl. B25J 9/16

(52) U.S. Cl. CPC B25J 9/1692; B25J 9/1697; B25J 9/1617

(57) ABSTRACT

Methods and apparatuses for calibrating an end effector feature for robotic assembly are disclosed. A method in accordance with an aspect of the present disclosure may comprise obtaining a first set of images of an effector feature coupled to an engagement feature of a robot, the first set of images including at least a first image of the effector feature from a first perspective and a second image of the effector feature from a second perspective, detecting an edge in each of the first image and the second image, determining a coordinate position of the effector feature in a first coordinate system based on the edge of the first image and the edge of the second image, and calibrating the robot based on the coordinate position of the effector feature in the first coordinate system.

### CROSS-REFERENCE TO RELATED APPLICATIONS

The present disclosure claims the benefit under 35 U.S.C. 119 of U.S. Provisional Patent Application No. 63/178,669, filed Apr. 23, 2021 and entitled “ROBOT CALIBRATION”, which application is incorporated by reference herein in its entirety.

### BACKGROUND

### Field

The present disclosure relates generally to robotic assembly of structures, and more specifically to calibration of robots used in robotic assembly of structures.

### Description of the Related Technology

Additive Manufacturing (AM) processes involve the use of a stored geometrical model for accumulating layered materials on a “build plate” to produce three-dimensional (3-D) objects having features defined by the model. AM techniques are capable of printing complex parts or components using a wide variety of materials. A 3-D object is fabricated based on a computer-aided design (CAD) model. The AM process can manufacture a solid three-dimensional object directly from the CAD model without additional tooling.

One example of an AM process is powder bed fusion (PBF), which uses a laser, electron beam, or other source of energy to sinter or melt powder deposited in a powder bed, thereby consolidating powder particles together in targeted areas to produce a 3-D structure having the desired geometry. Different materials or combinations of materials, such as metals, plastics, and ceramics, may be used in PBF to create the 3-D object. Other AM techniques, including those discussed further below, are also available or under current development, and each may be applicable to the present disclosure.

Another example of an AM process is called Binder Jet (BJ) process that uses a powder bed (similar to PBF) in which metallic powder is spread in layers and bonded by using an organic binder. The resulting part is a green part which requires burning off the binder and sintering to consolidate the layers into full density. The metallic powder material can have the same chemical composition and similar physical characteristics as PBF powders.

Another example of an AM process is called Directed Energy Deposition (DED). DED is an AM technology that uses a laser, electron beam, plasma, or other method of energy supply, such as those in Tungsten Inert Gas (TIG), or Metal Inert Gas (MIG) welding to melt the metallic powder or wire and rod, thereby transforming it into a solid metal object. Unlike many AM technologies, DED is not based on a powder bed. Instead, DED uses a feed nozzle to propel the powder or mechanical feed system to deliver wire and rod into the laser beam, electron beam, plasma beam, or other energy stream. The powdered metal or the wire and rod are then fused by the respective energy beam. While supports or a freeform substrate may in some cases be used to maintain the structure being built, almost all the raw material (powder, wire, or rod) in DED is transformed into solid metal, and consequently, little waste powder is left to recycle. Using a layer by layer strategy, the print head, comprised of the energy beam or stream and the raw material feed system, can scan the substrate to deposit successive layers directly from a CAD model.

PBF, BJ, DED, and other AM processes may use various raw materials such as metallic powders, wires, or rods. The raw material may be made from various metallic materials. Metallic materials may include, for example, aluminum, or alloys of aluminum. It may be advantageous to use alloys of aluminum that have properties that improve functionality within AM processes. For example, particle shape, powder size, packing density, melting point, flowability, stiffness, porosity, surface texture, density electrostatic charge, as well as other physical and chemical properties may impact how well an aluminum alloy performs as a material for AM. Similarly, raw materials for AM processes can be in the form of wire and rod whose chemical composition and physical characteristics may impact the performance of the material. Some alloys may impact one or more of these or other traits that affect the performance of the alloy for AM.

One or more aspects of the present disclosure may be described in the context of the related technology. None of the aspects described herein are to be construed as an admission of prior art, unless explicitly stated herein.

### SUMMARY

Several aspects of robotic assembly of structures, and more specifically to calibration of robots used in robotic assembly of structures, are described herein.

A method in accordance with an aspect of the present disclosure may comprise obtaining a first set of images of an effector feature coupled to an engagement feature of a robot, the first set of images including at least a first image of the effector feature from a first perspective and a second image of the effector feature from a second perspective, detecting an edge in each of the first image and the second image, determining a coordinate position of the effector feature in a first coordinate system based on the edge of the first image and the edge of the second image, and calibrating the robot based on the coordinate position of the effector feature in the first coordinate system.

Such a method further optionally includes the first image being captured by a first camera and the second image is captured by a second camera, wherein the first camera has a first field of view from the first perspective and the second camera has a second field of view at the second perspective, determining a coordinate position of the effector feature in a second coordinate system, comparing a first perspective position of the effector feature in the first image and a second perspective position of the effector feature in the second image, and triangulating the first perspective position with the second perspective position, sampling the first image and the second image every M lines of pixels, wherein M is an integer greater than or equal to 2 and detecting at least one edge on each sampled line of the first image and the second image, capturing a plurality of sets of images of the effector feature, and each set of images of the plurality of sets of images including at least a first image and a second image of the effector feature in the first coordinate system, wherein the first image is different from the second image in each set of images of the plurality of sets of images.

Such a method further optionally includes a position of the engagement feature in the first coordinate system being different for each set of images of the plurality of sets of images, comparing the plurality of sets of images to determine the coordinate position of the effector feature in the first coordinate system, determining a coordinate position of the effector feature in a second coordinate system, sampling the first image of each set of images in the plurality of sets of images and the second image of each set of images in the plurality of sets of images every M lines of pixels, wherein M is an integer greater than or equal to 2, and detecting at least one edge on each sampled line of the plurality of first images and plurality of second images, importing the coordinate position of the effector feature in the first coordinate system into a memory accessible to the robot, the effector feature being a nozzle tip,

An apparatus in accordance with an aspect of the present disclosure may comprise a robot having an engagement feature, an end effector coupled to the engagement feature, a first imaging device configured to capture at least a first image of the end effector from a first perspective, a second imaging device configured to capture at least a second image of the end effector from a second perspective, and a processor coupled to the first imaging device, the second imaging device, and the robot, the processor configured to: detect an edge in each of the first image and the second image, determine a coordinate position of the effector feature in a first coordinate system based on the edge of the first image and the edge of the second image, and calibrate the robot based on the coordinate position of the effector feature in the first coordinate system.

Such an apparatus may further optionally include the first imaging device including a first camera and the second imaging device includes a second camera, the first camera having a first field of view from the first perspective and the second camera having a second field of view at the second perspective, the first field of view overlapping with the second field of view, the coordinate position of the end effector in the first coordinate system being determined at least in part by determining a coordinate position of the end effector in a second coordinate system, and the coordinate position of the end effector in the first coordinate system being determined at least in part by comparing a first perspective position of the end effector in the first image and a second perspective position of the end effector in the second image and triangulating the first perspective position with the second perspective position.

Such an apparatus may further optionally include the coordinate position of the end effector in the first coordinate system being determined at least in part by detecting at least one edge of the end effector in the first image and in the second image, the coordinate position of the end effector in the first coordinate system being determined at least in part by sampling the first image and the second image every M lines of pixels, wherein M is an integer greater than or equal to 2 and detecting at least one edge on each sampled line of the first image and the second image, and the first imaging device being configured to capture a plurality of first images of the end effector from the first perspective and the second imaging device being configured to capture a plurality of second images of the end effector from the second perspective.

Such an apparatus may further optionally include the plurality of first images being different from the plurality of second images, a position of the effector feature in the first coordinate system being different for each image in the plurality of first images and each image in the plurality of second images, the coordinate position of the end effector in the first coordinate system being determined at least in part by comparing the plurality of first images and the plurality of second images, the coordinate position of the end effector in the first coordinate system being determined at least in part by determining a coordinate position of the end effector in a second coordinate system, the plurality of first images corresponding to a first perspective from a first position and the plurality of second images corresponding to a second perspective from a second position, the coordinate position of the end effector in the first coordinate system being determined at least in part by: determining a first perspective position of the end effector in the second coordinate system for each image in the plurality of first images, determining a second perspective position of the end effector in the second coordinate system for each image in the plurality of second images, and triangulating the plurality of first perspective positions with the plurality of second perspective positions.

Such an apparatus may further optionally include detecting at least one edge in each image in the plurality of sets of images, sampling the first image of each set of images in the plurality of sets of images and the second image of each set of images in the plurality of sets of images every M lines of pixels, wherein M is an integer greater than or equal to 2, and detecting at least one edge on each sampled line of the plurality of first images and plurality of second images, a memory, coupled to the robot, the processor being configured to import the coordinate position of the end effector in the first coordinate system into the memory, the end effector feature being a nozzle tip, the nozzle tip being configured to dispense a material, and the material including curable adhesive.

It will be understood that other aspects of structures and structures having sensors will become readily apparent to those of ordinary skill in the art from the following detailed description, wherein it is shown and described only several embodiments by way of illustration. As will be realized by those of ordinary skill in the art, the manufactured structures and the methods for manufacturing these structures are capable of other and different embodiments, and its several details are capable of modification in various other respects, all without departing from the disclosure. Accordingly, the drawings and detailed description are to be regarded as illustrative in nature and not as restrictive.

### BRIEF DESCRIPTION OF THE DRAWINGS

Various aspects of robotic assembly that may be used in manufacturing of structures, for example, in automotive, aerospace, and/or other engineering contexts are presented in the detailed description by way of example, and not by way of limitation, in the accompanying drawings, wherein:

FIG. 1 illustrates a functional block diagram of a computing system in accordance with an aspect of the present disclosure.

FIG. 2 illustrates a perspective view of an assembly system in accordance with an aspect of the present disclosure.

FIG. 3 illustrates a silhouette image of a nozzle in accordance with an aspect of the present disclosure.

FIG. 4 illustrates performance of an edge detection in accordance with an aspect of the present disclosure.

FIG. 5 illustrates performance of an edge detection in accordance with an aspect of the present disclosure.

FIG. 6 illustrates performance of an edge detection in accordance with an aspect of the present disclosure.

FIG. 7 illustrates performance of a center detection in accordance with an aspect of the present disclosure.

FIG. 8 illustrates performance of a tip detection in accordance with an aspect of the present disclosure.

FIG. 9 illustrates performance of an edge detection in accordance with an aspect of the present disclosure.

FIG. 10 illustrates performance of an edge detection in accordance with an aspect of the present disclosure.

FIG. 11 illustrates an example of subpixel edge detection in accordance with an aspect of the present disclosure.

FIG. 12 shows a flow diagram illustrating an exemplary method for calibration of a robot in accordance with an aspect of the present disclosure.

### DETAILED DESCRIPTION

The detailed description set forth below in connection with the appended drawings is intended to provide a description of various exemplary embodiments and not intended to represent the only embodiments in which the disclosure may be practiced. The term “exemplary” used throughout this disclosure means “serving as an example, instance, or illustration,” and should not necessarily be construed as preferred or advantageous over other embodiments presented in this disclosure. The detailed description includes specific details for the purpose of providing a thorough and complete disclosure that fully conveys the scope of the disclosure to those of ordinary skill in the art. However, the techniques and approaches of the present disclosure may be practiced without these specific details. In some instances, well-known structures and components may be shown in block diagram form, or omitted entirely, in order to avoid obscuring the various concepts presented throughout this disclosure.

One or more techniques described herein may enable the determination of the position of one or more effector features (e.g., a nozzle tip) of an end effector (e.g., a nozzle configure to dispense material) attached to an engagement feature of a robot in a robot coordinate system, increase the accuracy of movement, pathing, or positioning of one or more effector features of an end effector attached to a robot in a robot coordinate system, reduce error, calibrate a robot based on the coordinate position of one or more effector features of an end effector attached to the robot in a robot coordinate system, measurement and setting of a robot tool center point (TCP) for an effector feature of an end effector, or any combination thereof.

In some examples, the end effector may be a nozzle configured to dispense material (e.g., adhesive) and the effector feature of the end effector may correspond to the nozzle tip. To accurately dispense the material during a manufacturing process (e.g., an assembly process), the robot to which the end effector is attached needs to know the location of the effector feature in its own robot coordinate system. In some examples, the end effector may be a consumable item that needs to be replaced after a certain amount of use. However, due to manufacturing tolerances, different end effectors of the same type may have similar but nevertheless different dimensions. One or more techniques described herein enable determining the position of the effector feature of the end effector in a robot coordinate system every time the end effector is replaced and calibrating the robot based on the determined coordinate position in the robot coordinate system every such determination.

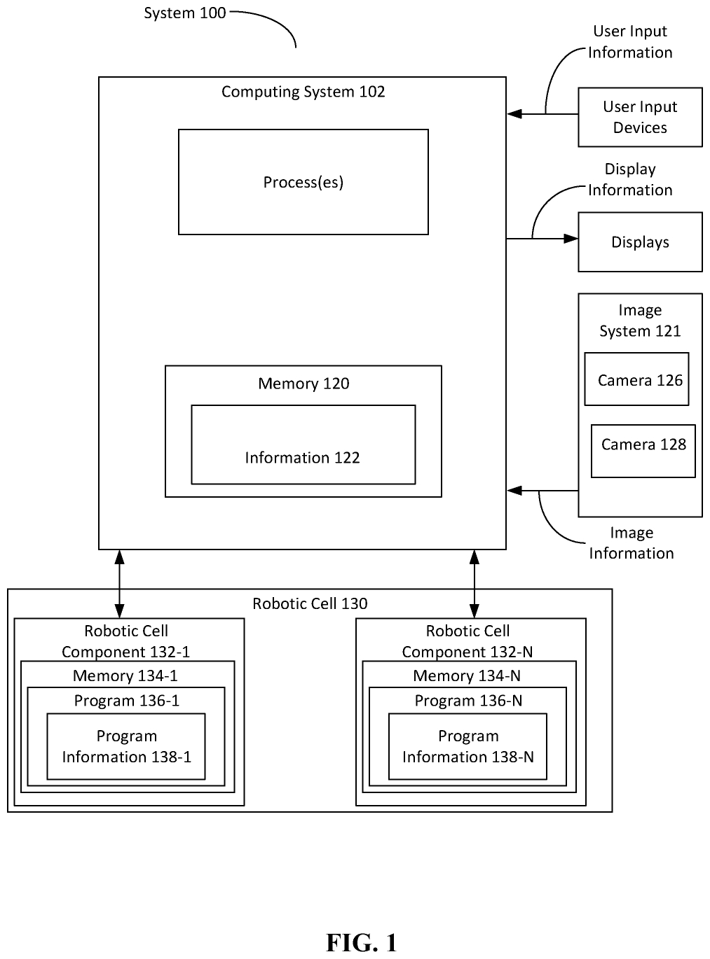

FIG. 1 illustrates a functional block diagram of a computing system in accordance with an aspect of the present disclosure.

FIG. 1 illustrates an example system 100 in which one or more techniques described herein may be employed. A component or a feature of any component of the example system 100 may be as described in this disclosure, including any description or technique described in the claims. A component or a feature of any component of the example system 100 may be configured to perform any function described in this disclosure, including the claims.

In the example shown in FIG. 1, system 100 may include a computing system 102, memory 120, one or more user input devices, one or more displays, an image system 121, and a robotic cell 130. Computing system 102 may be configured to perform one or more processes or techniques described herein. Computing system 102 may be a distributed computing system in some examples and a non-distributed computing system in other examples. The one or more user input devices may include any user input device, such as a mouse, keyboard, touchscreen, smartphone, computer, or any other input device. Computing system 102 may be communicatively coupled with one or more robotic cell components of robotic cell 130. Robotic cell 130 may be configured to assemble a plurality of parts into an assembly. Memory 120 may be configured to store information 122. Image system 121 may be configured to perform one or more processes or techniques described herein. Image system 121 may include a first camera 126 configured to capture one or more images from a first perspective and a second camera 128 configured to capture one or more images from a second perspective. The first camera 126 may be a machine vision camera and the second camera 128 may be a machine vision camera. The cameras 126/128 may both be stereo cameras. The first camera 126 may have a first field of view and the second camera 128 may have a second field of view. The first and second fields of view may be overlapping. Computing system 102 may be communicatively coupled with one or more components of image system 121.

In some examples, the first and second cameras 126/128 may be fixed to a frame such that their positions relative to each other are fixed. In other examples, the first camera 126 and second camera 128 may be positioned dynamically relative to each other. The spatial relationship between the first camera 126 and second camera 128 may be established through a calibration procedure using, for example, a known artifact (e.g., a checker pattern).

Robotic cell 130 may include one or more robotic cell components of robotic cell 130, which are depicted as robotic cell components 132-1 through 132-N, where N is an integer greater than or equal to 1 and represents the Nth robotic cell component of robotic cell 130. A robotic cell component can be, for example, a robot, a robotic arm, an automated guided vehicle (AGV), a motorized slide for moving a robot (e.g., linear translation), a part table, a computer processor, etc. For example, the one or more components of robotic cell 130 may include one or more robots and a processing system communicatively coupled to the one or more robots. A processing system of robotic cell 130 may be configured to provide information to the one or more robots and receive information from the one or more robots. Similarly, the one or more robots of robotic cell 130 may be configured to provide information to the processing system and receive information from the processing system. The information communicated between the one or more robots and the processing system of robotic cell 130 may include, for example, robot position information, robot movement information, robot state information, PLC state information, robot control information, robot program run information, calibration information, etc. In some examples, a processing system of robotic cell 130 may be a programmable logic controller (PLC).

Robotic cell 130 may include more than one processing system. For example, robotic cell 130 may include a first processing system (e.g., a first robot controller) corresponding to a first robotic cell component (e.g., a first robot) and a second processing system (e.g., a second robot controller) corresponding to a second robotic cell component (e.g., a second robot). In some examples, the first processing system may be a PLC and the second processing system may be a metrology system configured to measure various information regarding one or more robots of robotic cell 130. In some examples, the processing systems may be configured to provide and receive information between each other.

Each robotic cell component of robotic cell 130 may include a memory and a program stored on the memory that, when executed by a component of the robotic cell component, causes the cell component to perform one or more functions. For example, robotic cell component 132-1 may include a memory 134-1 with program 136-1 stored thereon, and robotic cell component 132-N may include a memory 134-N with program 136-N stored thereon. Each of programs 138-1 to 138-N may include program information 138-1 to 138-N, which may include, for example, calibration information described herein.

In some examples, a robotic cell component 132-N may include a robot with an engagement feature. The engagement feature may be coupled to an end effector. Computing system 102, a robot controller, or a combination thereof may be configured to cause the robot to position an effector feature of the end effector in the first and second fields of view of first and second cameras 126/128, which may be an overlapping field of view. To determine the position of the effector feature relative to the robot coordinate system, the robot may be exercised through a series of motions in which images of the effector feature may be captured by the image system 121. For example, the robot may be controlled to cause the effector feature to be positioned in N positions, where N is greater than or equal to 1. At each respective position of the N positions, the first camera 126 may be configured to capture an image when the effector feature is positioned in the overlapping field of view and the second camera 128 may be configured to capture an image when the effector feature is positioned in the overlapping field of view. The position of the effector feature may be recorded at each robot position along with the robot's position in the robot coordinate system. This data may be used to determine the coordinate position of the effector feature in the robot coordinate system.

Computing system 102 may be configured to receive image information from image system 121. Image information may include a plurality of images. Computing system 102 may be configured to compare images in the plurality of images, and the plurality of images may be from one or more perspectives. The plurality of images may include one or more sets of images. Each respective set of images may include a first image captured by first camera 126 and a second image captured by second camera 128 of one or more effector features of an end effector in a respective coordinate position in a robot coordinate system. In some examples, the robot coordinate system may be a flange coordinate system of the robot. For example, a first set of images may include a first image captured by first camera 126 and a second image of an effector feature of an end effector in a first coordinate position in a robot coordinate system, a second set of images may include a first image captured by first camera 126 and a second image captured by second camera 128 of an effector feature of an end effector in a second coordinate position in the robot coordinate system, and an Nth set of images may include a first image captured by first camera 126 and a second image captured by second camera 128 of an effector feature of an end effector in an Nth coordinate position in the robot coordinate system, where N is greater than or equal to 3. While it is described that the effector feature of the end effector in each image is in a respective coordinate position in the robot coordinate system, computing system 102 is configured to determine the respective coordinate position in the robot coordinate system by processing the images. Otherwise described, until the images are processed to determine the respective coordinate position, the effector feature is in the respective coordinate position but the coordinate position in the robot coordinate system is unknown even though the effector feature is in the position. Accordingly, computing system 102 may be configured to process each set of images to determine a respective coordinate position of the effector feature in the robot coordinate system for each respective set of images.

Information 122 stored on memory 120 may include input information and output information. In some examples, information may constitute both input information and output information. For example, computing system 102 may be configured to generate output information and later use the generated output information as an input in another process. Input information may include any information that computing system 102 may be configured to receive or process in accordance with the techniques of this disclosure, such as user input information received from one or more user input devices, image information received from image system 121, and information received from one or more robotic cell components of robotic cell 130. Output information may include any information that computing system 102 may be configured to provide or generate in accordance with the techniques of this disclosure, such as calibration information. Calibration information may include a coordinate position of the end effector determined from one or more sets of images. Computing system 102 may be configured to provide calibration information to the robot in robotic cell 130 to which the end effector is attached. For example, computing system 102 may be configured to cause calibration information to be imported into a memory accessible by a robot controller corresponding to the robot. As another example, computing system 102 may be configured to import calibration information into the memory accessible by the robot controller corresponding to the robot.

Computing system 102 may be communicatively coupled to the one or more user input devices, which may be configured to generate user input information in response to interaction by a user of system 100. Computing system 102 may be configured to receive user input information from the one or more user input devices. Computing system 102 may be configured to store user input information received from the one or more user input devices in memory 120. Computing system 102 may be configured to obtain information stored on memory 120 and perform one or more processes using the obtained information.

During use of image system 121, the effector feature may be positioned in the overlapping field of view of the first camera 126 and the second camera 128. The robot controller may be associated with the robot to which the end effector including the effector feature is attached. The first camera 126 may be configured to capture an image when the effector feature is positioned in the overlapping field of view and the second camera 128 may be configured to capture an image when the effector feature is positioned in the overlapping field of view.

In some examples, image system 121 may include a backlight. The backlight may enable silhouette images to be captured by the first camera 126 and the second camera 128 of image system 121. Silhouette images may enable more efficient image processing techniques to determine the location of the effector feature in each image, thereby reducing processing resource consumption. In other examples, image system 121 may not include a backlight.

Several aspects are disclosed herein and are described and illustrated by various systems, blocks, components, functions, processes, algorithms, etc. (collectively referred to as “components”). For example, each block in FIG. 1 may constitute a component. Components of this disclosure may be implemented using or otherwise include hardware, software, or any combination thereof configured to perform one or more aspects described with respect to the component. Whether such components are implemented as hardware or software may depend upon the particular application and design constraints imposed on the overall system. Components may be separate components or sub-components of a single component. By way of example, a component, any portion of a component, or any combination of components may be implemented as a computing system that includes one or more processors (which may also be referred to as processing units). Examples of processors may include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, programmable logic controllers (PLCs), gated logic, discrete hardware circuits, and other suitable hardware, configured to perform the various functionality described throughout this disclosure. The one or more processors of a computing system may be communicatively coupled in accordance with the techniques described herein. Any functional aspect disclosed herein may be performed by one or more components disclosed herein. The functionality performed by one or more components may be combined into a single component.

One or more processors, such as one or more processors of a computing system, may be configured to execute software stored on one or more memories communicatively coupled with the one or more processors. As an example, a processor may access software stored on a memory and execute the software accessed from the memory to perform one or more techniques described herein. Software may refer to instructions, code, etc.

Functionality described herein may be embodied or encoded as hardware, software, or any combination thereof. For example, if implemented in software, a function may be stored on or encoded as one or more instructions or code on a computer-readable medium. Computer-readable media includes computer storage media. Storage media may be any available media/memory that can be accessed by processor, such as random-access memory (RAM), read-only memory (ROM), electrically erasable programmable ROM (EEPROM), optical disk storage, magnetic disk storage, other magnetic storage devices, any other medium that may be used to store software, and any combination thereof. Computer-reasonable media may be non-transitory computer readable media.

As described herein, a computing system may refer to any combination of any number (one or more) of components configured to perform one or more techniques described herein. A computing system may include one or more components, devices, apparatuses, and/or systems on which one or more components of the computing system reside, such as a remote computing system, a server, base station, user equipment, client device, station, access point, a computer, an end product, apparatus, smart phone, or system configured to perform one or more techniques described herein. Any computing system herein may be a distributed computing system in some examples and a non-distributed computing system in other examples.

Any component herein may be configured to communicate with one or more other components. Communication may include the transmission and/or reception of information. The information may be carried in one or more messages. As an example, a first component in communication with a second component may be described as being communicatively coupled to or otherwise with the second component. As another example, any component described herein configured to perform one or more techniques of this disclosure may be communicatively coupled to one or more other components configured to perform one or more techniques of this disclosure. In some examples, when communicatively coupled, two components may be actively transmitting or receiving information, or may be configured to transmit or receive information. If not communicatively coupled, any two components may be configured to communicatively couple with each other, such as in accordance with one or more communication protocols compliant with one or more communication standards. Reference to “any two components” does not mean that only two devices may be configured to communicatively couple with each other; rather, any two devices is inclusive of more than two devices. For example, a first component may communicatively couple with a second component and the first component may communicatively couple with a third component.

In some examples, the term “coupled” or “communicatively coupled” may refer to a communication connection, which may be direct or indirect. A communication connection may be wired, wireless, or a combination thereof. A wired connection may refer to a conductive path, a trace, or a physical medium (excluding wireless physical mediums) over which information may be communicated. A conductive path may refer to any conductor of any length, such as a conductive pad, a conductive via, a conductive plane, a conductive trace, or any conductive medium. A direct communication connection may refer to a connection in which no intermediary component resides between the two communicatively coupled components. An indirect communication connection may refer to a connection in which at least one intermediary component resides between the two communicatively coupled components. Two components that are communicatively coupled may communicate with each other over one or more different types of networks (e.g., a wireless network and/or a wired network) in accordance with one or more communication protocols. In some examples, a communication connection may enable the transmission and/or receipt of information. For example, a first component communicatively coupled to a second component may be configured to transmit information to the second component and/or receive information from the second component in accordance with the techniques of this disclosure. Similarly, the second component in this example may be configured to transmit information to the first component and/or receive information from the first component in accordance with the techniques of this disclosure. The term “communicatively coupled” may refer to a temporary, intermittent, or permanent communication connection.

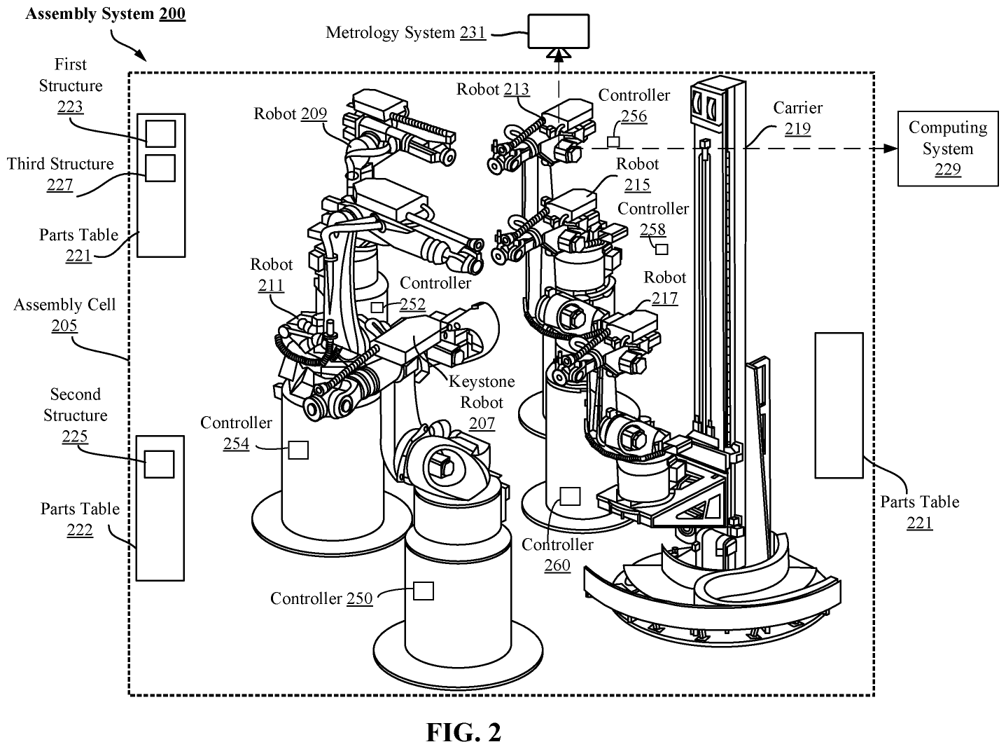

FIG. 2 illustrates a perspective view of an assembly system in accordance with an aspect of the present disclosure.

In an aspect of the present disclosure, mechanical devices, such as robots, may assemble parts and/or structures in an automated and/or semi-automated manner. Structures to be joined in association with assembly of a vehicle may be additively manufactured with one or more features that may facilitate or enable various assembly operations (e.g., joining). In an aspect of the present disclosure, an assembly system 200 may include two robots, at least one of which may be positioned to join one structure with another structure without the use of fixtures. Various assembly operations may be performed, potentially repeatedly, so that multiple structures may be joined for fixtureless assembly of at least a portion of a vehicle (e.g., vehicle chassis, body, panel, and the like).

In an aspect of the present disclosure, an assembly system 200 may use one or more assembly cells 205, which may be similar to robotic cells 130 as described with respect to FIG. 1, in the construction of assemblies or final products. In such an aspect, a first robot may be configured to engage with and retain a first structure to which one or more other structures may be joined during various operations performed in association with assembly of at least a portion of an end product, such as a vehicle. For example, the first structure may be a section of a vehicle chassis, panel, base piece, body, frame, etc., whereas other structures may be other sections of the vehicle chassis, panel, base piece, body, frame, etc.

In an aspect of the present disclosure, the first robot may engage and retain a first structure that is to be joined with a second structure, and the second structure may be engaged and retained by a second robot. Various operations performed with the first structure (e.g., joining the first structure with one or more other structures, which may include two or more previously joined structures) may be performed at least partially within an assembly cell that includes a plurality of robots. Accordingly, at least one of the robots may be directed (e.g., controlled) during manipulation of the first structure in order to function in accordance with a precision commensurate with the joining operation.

The present disclosure provides various different embodiments of directing one or more robots at least partially within an assembly system for assembly operations (including pre- and/or post-assembly operations). It will be appreciated that various embodiments described herein may be practiced together. For example, an embodiment described with respect to one illustration of the present disclosure may be implemented in another embodiment described with respect to another illustration of the present disclosure.

As shown in FIG. 2, an assembly system 200 may be employed for component and/or part assembly. An assembly cell 205 may be configured at the location of fixtureless assembly system 200. Assembly cell 205 may be a vertical assembly cell. Within assembly cell 205, fixtureless assembly system 200 may include a set of robots 207, 209, 211, 213, 215, 217. Robot 207 may be referred to as a “keystone robot.” Fixtureless assembly system 200 may include parts tables 221, 222 that can hold parts and structures for the robots to access. For example, a first structure 223, a second structure 225, and a third structure 227 may be positioned on one of parts tables 221, 222 to be picked up by the robots and assembled together. The weight and volume of the structures may vary without departing from the scope of the present disclosure. In various embodiments, one or more of the structures can be an additively manufactured structure, such as a complex node.

Assembly system 200 may also include a computing system 229 to issue commands to the various controllers of the robots of assembly cell 205, as described in more detail below. In this example, computing system 229 is communicatively connected to the robots through a wireless communication network. Fixtureless assembly system 200 may also include a metrology system 231 that can accurately measure the positions of the robotic arms of the robots and/or the structures held by the robots. Computing system 229 and/or metrology system 231 may be controlled by and/or part of computing system 102 and/or image system 121 as described with respect to FIG. 1.

Keystone robot 207 may include a base and a robotic arm. The robotic arm may be configured for movement, which may be directed by computer-executable instructions loaded into a processor communicatively connected with keystone robot 207. Keystone robot 207 may contact a surface of assembly cell 205 (e.g., a floor of the assembly cell) through the base.

Keystone robot 207 may include and/or be connected with an end effector and/or fixture that is configured to engage and retain a first structure, part, and/or component. An end effector may be a component configured to interface with at least one structure. Examples of the end effectors may include jaws, grippers, pins, and/or other similar components capable of facilitating fixtureless engagement and retention of a structure by a robot. A fixture may also be employed by keystone robot 207 to engage and retain a first structure, part, and/or component.

For example, a structure may be co-printed with one or more features that increase the strength of the structure, such as a mesh, honeycomb, and/or lattice arrangement. Such features may stiffen the structure to prevent unintended movement of the structure during the assembly process. In another example, a structure may be co-printed or additively manufactured with one or more features that facilitates engagement and retention of the structure by an end effector, such as protrusion(s) and/or recess(es) suitable to be engaged (e.g., “gripped”) by an end effector. The aforementioned features of a structure may be co-printed with the structure and therefore may be of the same material(s) as the structure.

In retaining the first structure, keystone robot 207 may position (e.g., move) the first structure; that is, the position of the first structure may be controlled by keystone robot 207 when retained by the keystone robot. Keystone robot 207 may retain the first structure by “holding” or “grasping” the first structure, e.g., using an end effector of a robotic arm of the keystone robot 207 and/or using a fixture to maneuver the first structure. For example, keystone robot 207 may retain the first structure by causing gripper fingers, jaws, and the like to contact one or more surfaces of the first structure and apply sufficient pressure thereto such that the keystone robot controls the position of the first structure. That is, the first structure may be prevented from moving freely in space when retained by keystone robot 207, and movement of the first structure may be constrained by the keystone robot 207.

As other structures (including subassemblies, substructures of structures, etc.) are connected to the first structure, keystone robot 207 may retain the engagement with the first structure. The aggregate of the first structure and one or more structures connected thereto may be referred to as a structure itself, but may also be referred to as an “assembly” or a “subassembly” herein. Keystone robot 207 may also retain an engagement with an assembly once the keystone robot has engaged the first structure.

In some embodiments, robots 209 and 211 of assembly cell 205 may be similar to keystone robot 207, and thus may include respective end effectors and/or fixtures configured to engage with structures that may be connected with the first structure when retained by the keystone robot 207. In some embodiments, robots 209, 211 may be referred to as “assembly robots” and/or “materials handling robots.”

In some embodiments, robot 213 of assembly cell 205 may be used to effect a structural connection between the first structure and the second structure. Robot 213 may be referred to as a “structural adhesive robot.” Structural adhesive robot 213 may be similar to the keystone robot 207, except the structural adhesive robot may include an end effector, such as a nozzle configured to dispense a structural adhesive, at the distal end of the robotic arm that is configured to apply structural adhesive to at least one surface of structures retained by the keystone robot 207 and/or assembly robots 209, 211. Application of the structural adhesive may occur before or after the structures are positioned at joining proximities with respect to other structures for joining with the other structures. The joining proximity can be a position that allows a first structure to be joined to a second structure. For example, in various embodiments, the first and second structures may be joined through the application of an adhesive while the structures are within their joining proximity.

However, structural adhesives might take a relatively long time to cure. If this is the case, the robots retaining the first and second structures, for example, might have to hold the structures at the joining proximity for a long time. This would prevent the robots from being used for other tasks, such as continuing to pick up and assemble structures, for an extended time while the structural adhesive cures. In order to allow more efficient use of the robots, a quick-cure adhesive may be additionally applied in some embodiments to join the structures quickly and retain the structures so that the structural adhesive can cure without requiring both robots to hold the structures during curing.

In an aspect of the present disclosure, robot 215 of fixtureless assembly system 200 may be used to apply a quick-cure adhesive. In such an aspect, a quick-cure UV adhesive may be used, and robot 215 may be referred to as a “UV robot.” UV robot 215 may be similar to keystone robot 207, except the UV robot may include an end effector, such as a nozzle configured to dispense a UV adhesive, at the distal end of the robotic arm that is configured to apply a quick-cure UV adhesive and to cure the adhesive, e.g., when the structures are positioned within the joining proximity. That is, UV robot 215 may cure a curable adhesive, such as a UV-curable adhesive or heat-curable adhesive, after the adhesive is applied to the first structure and/or second structure when the structures are within the joining proximity of the robotic arms of keystone robot 207 and/or assembly robots 209, 211.

In an aspect of the present disclosure, one or more of the robots 207, 209, 211, 213, 215, and 217 may be used for multiple different roles. For example, robot 217 may perform the role of an assembly robot, such as assembly robots 209, 211, and the role of a UV robot, such as UV robot 215. In this regard, robot 217 may be referred to as an “assembly/UV robot.” Assembly/UV robot 217 may offer functionality similar to each of the assembly robots 209, 211 when the distal end of the robotic arm of the assembly/UV robot includes an end effector (e.g., connected by means of an engagement feature, such as a tool flange). However, assembly/UV robot 215 may offer multi-functional capabilities similar to UV robot 215 when the distal end of the robotic arm of the assembly/UV robot includes an end effector configured to applied UV adhesive and to emit UV light to cure the UV adhesive.

The quick-cure adhesive applied by UV robot 215 and assembly/UV robot 217 may provide a partial adhesive bond in that the adhesive may be used to hold the relative positions of a first structure and a second structure within the joining proximity until the structural adhesive is applied to permanently join them. The adhesive providing the partial adhesive bond may be removed thereafter (e.g., as with temporary adhesives) or not (e.g., as with complementary adhesives).

End effectors, such as the nozzles used to apply the structural and UV adhesives described above, may need to be changed periodically. In this regard, each of the various robots of assembly cell 205 may periodically remove its end effector at the end of the end effector's useful life and replace it with a new end effector. As described above, the dimensions of end effectors of the same type may vary due to, for example, manufacturing tolerances. Therefore, after the robot has replace its end effector, a calibration procedure as describe herein may be performed before the robot continues assembly operations. This calibration can allow the robot position an effector feature, such as a nozzle tip, accurately during the assembly operations, even if the new nozzle has different dimensions than the old nozzle.

In a fixtureless assembly system 200, at least one surface of the first structure and/or second structure to which adhesive is to be applied may be determined based on gravity or other load-bearing forces on various regions of the assembly. Finite element method (FEM) analyses may be used to determine the at least one surface of the first structure and/or the second structure, as well as one or more discrete areas on the at least one surface, to which the adhesive is to be applied. For example, FEM analyses may indicate one or more connections of a structural assembly that may be unlikely or unable to support sections of the structural assembly disposed about the one or more connections. FEM analyses may also be used to determine the positioning of an end effector attached to a distal end of an arm of UV robot 215 in an aspect of the present disclosure.

In assembling at least a portion of a vehicle in assembly cell 205, the second structure may be joined directly to the first structure by directing the various robots 207, 209, 211, 213, 215, and 217 as described herein. Additional structures may be indirectly joined to the first structure. For example, the first structure may be directly joined to the second structure through movement(s) of keystone robot 207, structural adhesive robot 213, at least one assembly robot 209, 211, and/or UV robot 215. Thereafter, the first structure, joined with the second structure, may be indirectly joined to an additional structure as the additional structure is directly joined to the second structure. Thus, the first structure, which may continue to be retained by keystone robot 207, may evolve throughout an assembly process as additional structures are directly or indirectly joined to it.

In an aspect of the present disclosure, assembly robots 209, 211 may join two or more structures together, e.g., with a partial, quick-cure adhesive bond, before joining those two or more structures with the first structure retained by keystone robot 207. The two or more structures that are joined to one another prior to being joined with a structural assembly may also be a structure, and may further be referred to as a “subassembly.” Accordingly, when a structure forms a portion of a structural subassembly that is connected with the first structure through movements of keystone robot 207, structural adhesive robot 213, at least one assembly robot 209, 211, and UV robot 215, a structure of the structural subassembly may be indirectly connected to the first structure when the structural subassembly is joined to a structural assembly including the first structure.

In an aspect of the present disclosure, the structural adhesive may be applied, e.g., deposited in a groove of one of the structures, before the first and second structures are brought within the joining proximity. For example, structural adhesive robot 213 may include a dispenser for a structural adhesive and may apply the structural adhesive prior to the structures being brought within the joining proximity. A structural adhesive may be applied after a structural assembly is fully constructed (that is, once each structure of the portion of the vehicle is joined to the first structure). For example, the structural adhesive may be applied to one or more joints or other connections between the first structure and the second structure. The structural adhesive may be applied at a time after the last adhesive curing by the UV robot 215 is performed. The structural adhesive may also be applied separately from fixtureless assembly system 200.

In an aspect of the present disclosure, one or more of robots 207, 209, 211, 213, 215, 217 may be secured to a surface of assembly cell 205 through a respective base of each of the robots. For example, one or more of the robots may have a base that is bolted to the floor of the assembly cell 205. In various other embodiments, one or more of the robots may include or may be connected with a component configured to move the robot within assembly cell 205. For example, a carrier 219 in assembly cell 205 may be connected to assembly/UV robot 217.

Each of the robots 207, 209, 211, 213, 215, 217 may be communicatively connected with a controller, such as a controllers 250, 252, 254, 256, 258, 260 shown in FIG. 2. Each of controllers 250, 252, 254, 256, 258, 260 may include, for example, a memory and a processor communicatively connected to the memory (e.g., memory 120 as described with respect to FIG. 1). According to some other embodiments, one or more of controllers 250, 252, 254, 256, 258, 260 may be implemented as a single controller that is communicatively connected to one or more of the robots controlled by the single controller. Controllers 250, 252, 254, 256, 28, and/or 260 may be part of, or controlled by, computing system 102 as described with respect to FIG. 1.

Computer-readable instructions for performing fixtureless assembly can be stored on the memories of controllers 250, 252, 254, 256, 258, 260 and the processors of the controllers can execute the instructions to cause robots 207, 209, 211, 213, 215, 217 to perform various operations.

Controllers 250, 252, 254, 256, 258, 260 may be communicatively connected to one or more components of an associated robot 207, 209, 211, 213, 215, or 217, for example, via a wired (e.g., bus or other interconnect) and/or wireless (e.g., wireless local area network, wireless intranet) connection. Each of the controllers may issue commands, requests, etc., to one or more components of the associated robots, for example, in order to perform various operations.

In an aspect of the present disclosure, controllers 250, 252, 254, 256, 258, 260 may issue commands, etc., to a robotic arm of the associated robot 207, 209, 211, 213, 215, or 217 and, for example, may direct the robotic arms based on a set of absolute coordinates relative to a global cell reference frame of assembly cell 205. In various embodiments, controllers 250, 252, 254, 256, 258, 260 may issue commands, etc., to end effectors connected to the distal ends of the robotic arms. For example, the controllers may control operations of the end effectors, including depositing a controlled amount of adhesive on a surface of the first structure or second structure by an adhesive applicator, exposing adhesive deposited between structures to UV light for a controlled duration by a curing tool, and so forth. In various embodiments, controllers 250, 252, 254, 256, 258, 260 may issue commands, etc., to end effectors at the distal ends of the robotic arms. For example, the controllers may control operations of the end effectors, including, engaging, retaining, and/or manipulating a structure.

According to various other aspects, a computing system, such as computing system 229, similarly having a processor and memory, may be communicatively connected with one or more of controllers 250, 252, 254, 256, 258, 260. In various embodiments, the computing system may be communicatively connected with the controllers via a wired and/or wireless connection, such as a local area network, an intranet, a wide area network, and so forth. In some embodiments, the computing system may be implemented in one or more of controllers 250, 252, 254, 256, 258, 260. In some other embodiments, the computing system may be located outside assembly cell 205, e.g., as part of computing system 102 described with respect to FIG. 1.

The processor of the computing system may execute instructions loaded from memory, and the execution of the instructions may cause the computing system to issue commands, etc., to the controllers 250, 252, 254, 256, 258, 260, such as by transmitting a message including the command, etc., to one of the controllers over a network connection or other communication link.

According to some embodiments, one or more of the commands may indicate a set of coordinates and may indicate an action to be performed by one of robots 207, 209, 211, 213, 215, 217 associated with the one of the controllers that receives the command. Examples of actions that may be indicated by commands include directing movement of a robotic arm, operating an end effector, engaging a structure, rotating and/or translating a structure, and so forth. For example, a command issued by a computing system may cause controller 252 of assembly robot 209 to direct a robotic arm of assembly robot 209 so that the distal end of the robotic arm may be located based on a set of coordinates that is indicated by the command.

The instructions loaded from memory and executed by the processor of the computing system, which cause the controllers to control actions of the robots may be based on computer-aided design (CAD) data. For example, a CAD model of assembly cell 205 (e.g., including CAD models of the physical robots) may be constructed and used to generate the commands issued by the computing system.

In some embodiments, one or more CAD models may represent locations corresponding to various elements within the assembly cell 205. Specifically, a CAD model may represent the locations corresponding to one or more of robots 207, 209, 211, 213, 215, 217. In addition, a CAD model may represent locations corresponding to structures and repositories of the structures (e.g., storage elements, such as parts tables, within fixtureless assembly system 200 at which structures may be located before being engaged by an assembly robot). In various embodiments, a CAD model may represent sets of coordinates corresponding to respective initial or base positions of each of robots 207, 209, 211, 213, 215, 217.

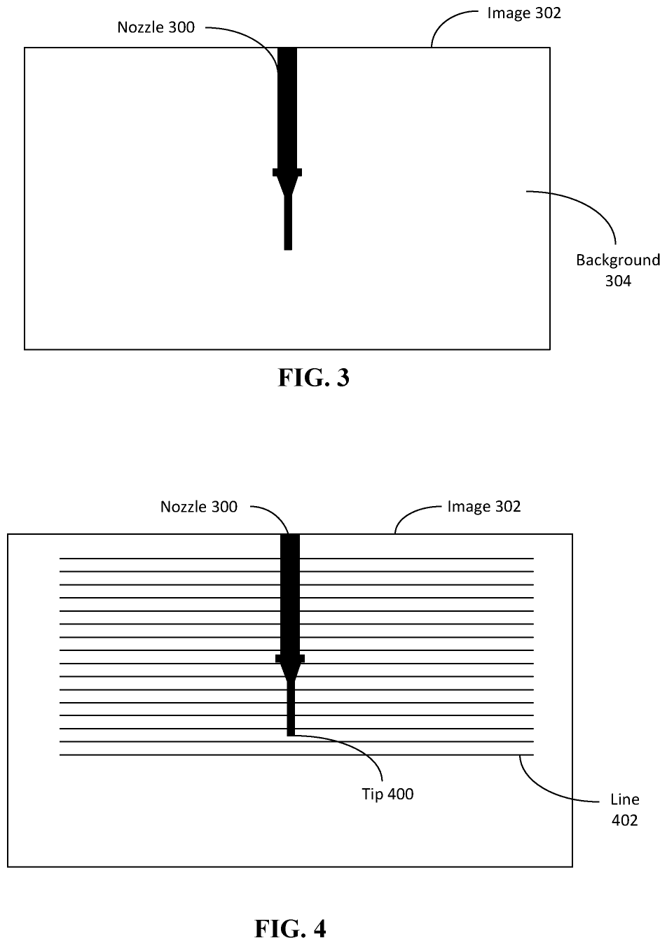

FIG. 3 illustrates a silhouette image of a nozzle in accordance with an aspect of the present disclosure.

As described with respect to FIG. 2, one or more robots 207, 209, 211, 213, 215, 217 in assembly cell 205 may include one or more end effectors, such as nozzle 300, that may be attached via engagement features to arms of various robots 207, 209, 211, 213, 215, 217 within assembly cell 205. As shown, image 302 of nozzle 300 may be taken by metrology system 231 and/or imaging system 121 to show nozzle 300 as a silhouette image 302 against a background 304, which may be a white or otherwise colored background that contrasts with the color of nozzle 300.

Computing system 102, or controllers 250, 252, 254, 256, 258, 260, may be configured to create a threshold of an image 302 of nozzle 300 against background 304 to increase the contrast between nozzle 300 and background 304. For example, and as shown in FIG. 3, the image 302 of nozzle 300 may appear completely black, while background 304 may appear completely white. Background 304 may be a backlight to help increase the contrast between pixels in imaging system 121 and/or metrology system 231.

FIG. 4 illustrates an edge detection in accordance with an aspect of the present disclosure.

FIG. 4 illustrates an example of edge detection that may be performed on one or more images captured by image system 121 and/or metrology system 231.

In an aspect of the present disclosure, computing system 102 may be configured to perform the edge detection of nozzle 300 and/or a location of a nozzle tip 400 of the nozzle against background 304. In some examples, computing system 102 may perform edge detection on every line 402 of pixels in image 302. In other examples, computing system 102 may sample the image 302 every M lines 402 of pixels and computing system 102 may perform edge detection on each sampled line 402 of pixels. In some examples, M may be greater than or equal to 2, 4, 6, 8, 10, 15, 20, 25, 50, or 100 pixels. The horizontal lines 402 in FIG. 4 indicate represent sampled lines of pixels. The spacing between sampled lines 402 can be varied without departing from the scope of the present disclosure. The location of tip 400 may be determined by multiple measurements of lines 402 of pixels, through interpolation of lines 402 of pixels, or other methods without departing from the scope of the present disclosure.

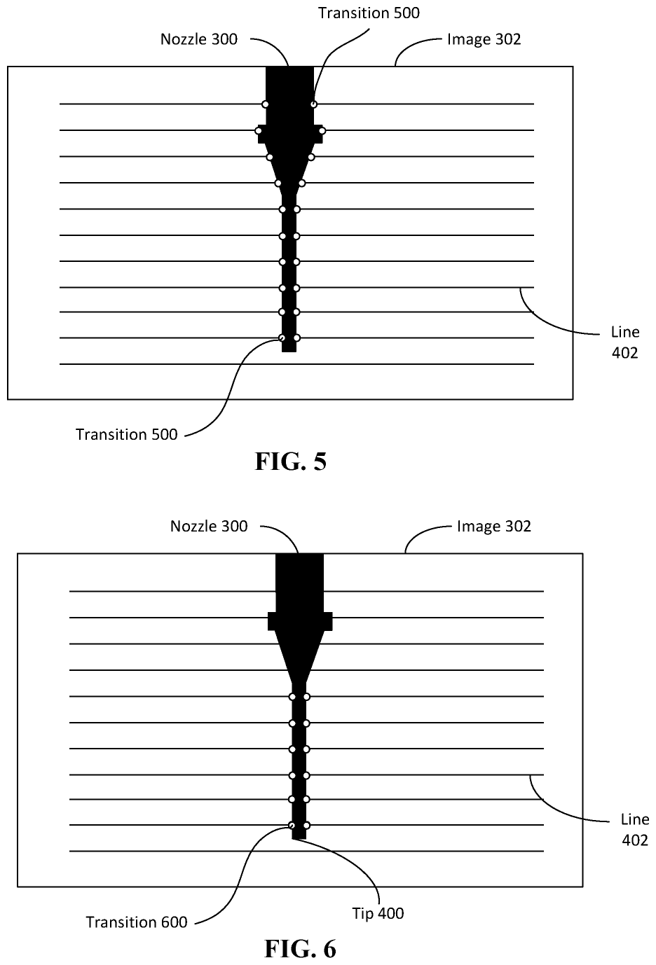

FIG. 5 illustrates performance of an edge detection in accordance with an aspect of the present disclosure.

FIG. 5 illustrates that the transitions 500 between background 304 and nozzle 300 in image 302 may be detected along each sampled line 402. The detected edges, or transitions 500, of nozzle 300 on the sampled lines 402 of pixels are represented by circular points in FIG. 5. Computing system 102 may be configured to determine, based on the geometry of the detected edges where an effector feature, such as tip 400, is located in the image 302.

FIG. 6 illustrates performance of an edge detection in accordance with an aspect of the present disclosure.

FIG. 6 illustrates an example where computing system 102 is configured to determine that the identified detected edges, i.e., transitions 600, in the lower half of image 302 of the same width correspond to a particular portion, e.g., the lower or cylindrical portion, of the nozzle 300. Computing system 102 may be configured to discard other detected edges or transitions of pixels on lines 402.

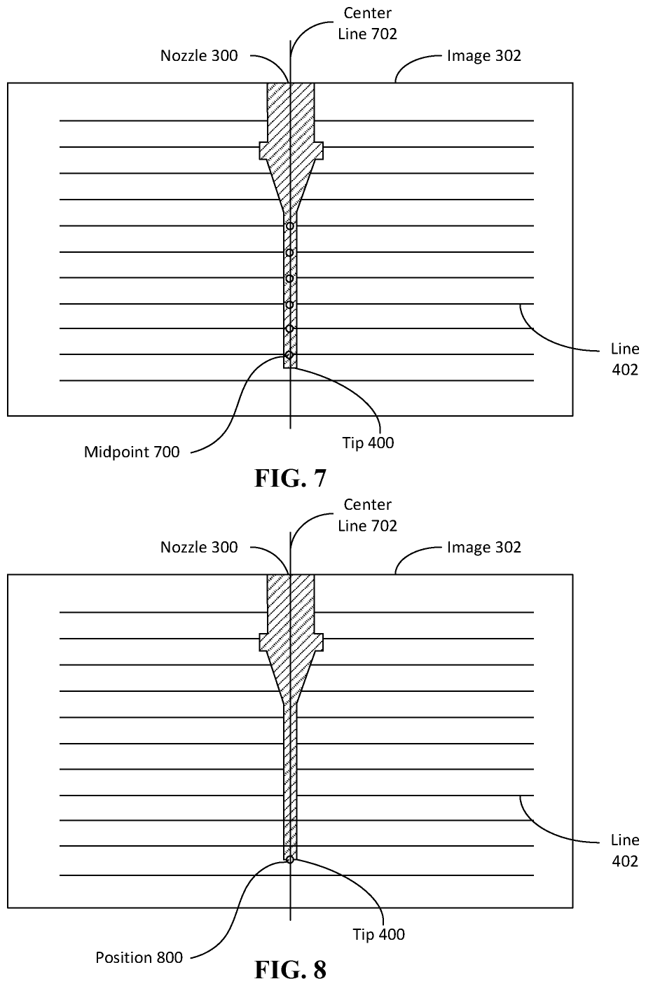

FIG. 7 illustrates performance of a center detection in accordance with an aspect of the present disclosure.

FIG. 7 illustrates that computing system 102 may be configured to determine the midpoint 700, or center, between each respective pair of detected edge pixels (transitions 600) on each sampled line 402 of pixels. The midpoints 700 are represented by circular points in FIG. 7. FIG. 7 also illustrates that computing system 102 may be configured to fit a center line 702 through the determined midpoints 700. Nozzle 300 is shown as shaded to better illustrate the fitting of center line 702 through the determined midpoints 700.

FIG. 8 illustrates performance of a tip detection in accordance with an aspect of the present disclosure.

FIG. 8 illustrates that computing system 102 may be configured to determine a position 800 of the nozzle tip 400. In an aspect of the present disclosure, computing system 102 may use edge detection along the pixels overlapping with the fitted center line 702. The nozzle tip 400 location, or approximate central position of nozzle tip 400, is represented by the circular point labeled “position 800” in FIG. 8.

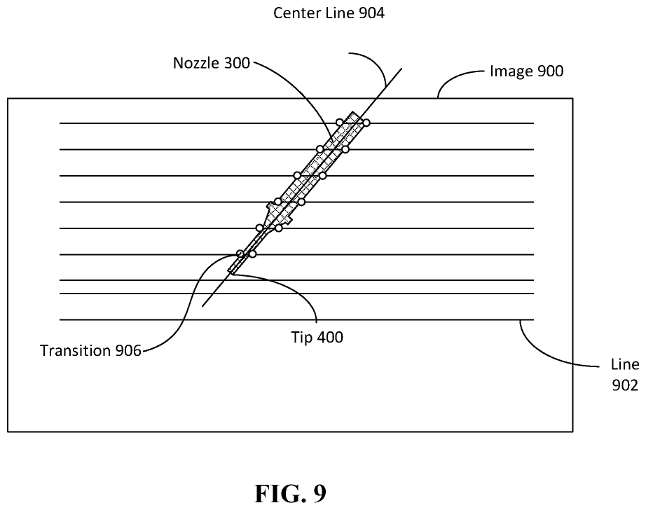

FIG. 9 illustrates performance of an edge detection in accordance with an aspect of the present disclosure.

FIG. 9 illustrates that computing system 102 may be configured to perform the processes disclosed with respect to FIGS. 3-8 when the nozzle 300 is angled in the image 900. In examples where the nozzle 300 is angled in the image 900, computing system may be configured to sample lines 902 of pixels that are at angles to the nozzle 300, and a center line 904 may be determined through interpolation of transitions 906 or by other methods. Computing system 102 may determine the tip 400 location of nozzle 300 in a similar manner as described with respect to FIGS. 3-8.

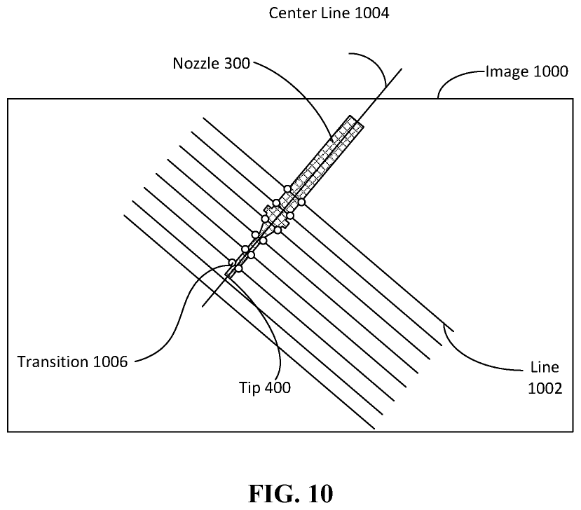

FIG. 10 illustrates performance of an edge detection in accordance with an aspect of the present disclosure.

As shown in FIG. 10, image 1000 may be processed by computing system 102 where lines 1002 of pixels are normal to nozzle 300, such that center line 1004 and transitions 1006 are determined in a rotated plane to that shown in FIGS. 3-8. Similar processes may be undertaken by computing system 102 as described in FIGS. 3-8, using angled sample lines 1002 of pixels instead of horizontal sample lines 402 of pixels.

In any of FIGS. 3-10, Computing system 102 may be configured to perform triangulation based on the effector feature/nozzle 300 position determined through image processing of one or more images 302. The points in the triangulation may include the effector feature/nozzle 300 position in each image in each processed set of images and the position of each camera 126/128 within image system 121 when the images 302 were captured.

In an aspect of the present disclosure, triangulation may require three or more sets of images 302 to be processed. In some examples, the position of a camera 126/128 within image system 121 may refer to a position of the viewpoint of a camera 126/128. By performing triangulation, computing system 102 may be configured to determine the three-dimensional position of the effector feature/nozzle 300 position, or specific portion of effector feature/nozzle 300 position, e.g., the position of tip 400, etc., in three degrees of freedom (DOF) based on the geometric relationship between a first camera 126 and a second camera 128 within image system 121. Each set of images 302 corresponds to a respective known coordinate position of a robot 207, 209, 211, 213, 215, and/or 217 within robotic cell 130 when each respective set of images 302 is captured.

In an aspect of the present disclosure, a first set of images 302 may correspond to a known first coordinate position of the robot 207, 209, 211, 213, 215, and/or 217 (e.g., the location of where the end effector/nozzle 300 is attached to the robot 207, 209, 211, 213, 215, and/or 217) when the first set of images 302 were captured, a second set of images 302 may correspond to a known second coordinate position of the robot 207, 209, 211, 213, 215, and/or 217 (e.g., the location of where the end effector feature/nozzle 300 is attached to the robot 207, 209, 211, 213, 215, and/or 217) when the second set of images 302 were captured, and a third set of images 302 may correspond to a known third coordinate position of the robot 207, 209, 211, 213, 215, and/or 217 (e.g., the location of where the end effector, e.g., nozzle 300 is attached to the robot 207, 209, 211, 213, 215, and/or 217) when the third set of images 302 were captured. The images 302 may be compared by computing system 102.

In such an aspect, computing system 102 may be configured to determine, by performing triangulation or comparison, a first three-dimensional position in three DOF of the effector feature/nozzle 300, corresponding to the first known coordinate position of the robot 207, 209, 211, 213, 215, and/or 217, a second three-dimensional position in three DOF of the end effector/nozzle 300 feature corresponding to the second known coordinate position of the robot 207, 209, 211, 213, 215, and/or 217, and a third three-dimensional position in three DOF of the end effector/nozzle 300 feature corresponding to the third known coordinate position of the robot 207, 209, 211, 213, 215, and/or 217. Computing system 102 may be configured to store a mapping table that maps the first three-dimensional position in three DOF to the first known coordinate position of the robot 207, 209, 211, 213, 215, and/or 217, the second three-dimensional position in three DOF to the second known coordinate position of the robot 207, 209, 211, 213, 215, and/or 217, and the third three-dimensional position in three DOF to the third known coordinate position of the robot 207, 209, 211, 213, 215, and/or 217. The three DOF positions may be in a coordinate system corresponding to the image system 121, such as a camera space coordinate system. The coordinate system may also be an absolute coordinate system that relates the known coordinate positions to a position within the assembly cell 205. Other coordinate systems may be used without departing from the scope of the present disclosure.

After performing triangulation to generate the information stored in the mapping table, computing system 102 may be configured to process the information stored in the mapping table to determine a coordinate position of the effector feature/nozzle 300 in the robot coordinate system. The determined coordinate position of the effector feature/nozzle 300 may be used to calibrate robot 207, 209, 211, 213, 215, and/or 217, and the determined coordinate position of the effector feature/nozzle 300 may be considered as calibration information for robot 207, 209, 211, 213, 215, and/or 217. In some examples, the robot coordinate system may be a six DOF coordinate system and the determined coordinate position of the effector feature/nozzle 300 in the robot coordinate system may be expressed in six DOF. The determined coordinate position may also be transformed from one coordinate system to another, or may be correlated to other coordinate systems. The effector feature/nozzle 300 position may be used to calibrate, direct, and/or operate robot 207, 209, 211, 213, 215, and/or 217, such that effector feature/nozzle 300 may be placed in a desired location with respect to parts that are to be assembled within assembly cell 205.

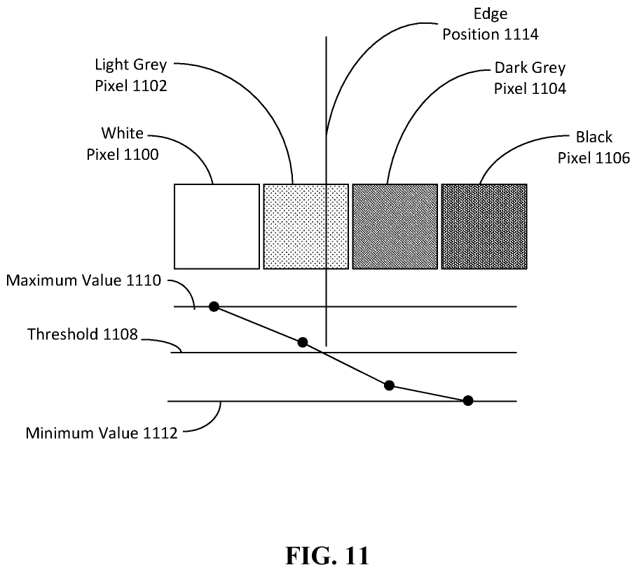

FIG. 11 illustrates an example of subpixel edge detection in accordance with an aspect of the present disclosure.

As shown in FIG. 11, white pixel 1100, light grey pixel 1102, dark grey pixel 1104, and black pixel 1106 are shown from left to right. Below the four pixels 1100-1106 is a graph showing the pixel 1100-1106 values on a black/white scale based on the intensity or pixel value of each respective pixel 1100-1106. A threshold 1108 line may be used to find a point between the maximum value 1110 corresponding to white pixel 1100 and minimum value 1112 corresponding to minimum value 1112. Threshold 1108 may be an average value of maximum value 1110 and minimum value 1112, a weighted average, or other value between the maximum value 1110 and minimum value 1112. The vertical line corresponds to a subpixel location that corresponds to edge position 1114 of the effector feature/nozzle 300.

Intermediate colors of pixels, such as pixels 1102 and 1104, may be converted to white pixels 1100 or black pixels 1106 depending on whether the gray value or intermediate color has a value below or above a desired threshold, e.g., threshold 1108. Computing system 102 may be configured to use the gray pixel 1102/1104 information (e.g., the value and location of all gray pixels 1102/1104) to determine the subpixel location of the nozzle 300 edges. For example, computing system 102 may be configured to determine a more accurate edge position, e.g., transition 500, transition 600, etc., by using subpixel edge detection. In such an example, computing system 102 may be configured to analyze individual pixels 1100-1106 in a sampled line of pixels and interpolate between white pixels 1100 and black pixels 1106 to find the subpixel location where the intensity is an average between black pixels 1106 and white pixels 1100.

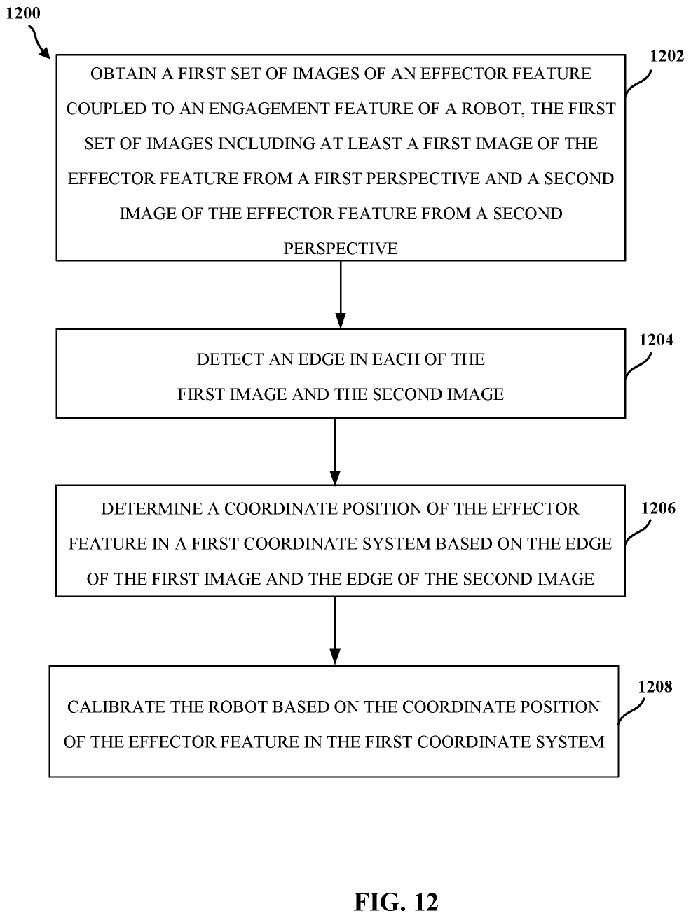

FIG. 12 shows a flow diagram illustrating an exemplary method for calibration of a robot in accordance with an aspect of the present disclosure.

FIG. 12 shows a flow diagram illustrating an exemplary method 1200 for calibration of a robot in accordance with an aspect of the present disclosure. The objects that perform, at least in part, the exemplary functions of FIG. 12 may include, for example, computing system 102 and one or more components therein, and other objects that may be used for forming the above-referenced materials.

It should be understood that the steps identified in FIG. 12 are exemplary in nature, and a different order or sequence of steps, and additional or alternative steps, may be undertaken as contemplated in this disclosure to arrive at a similar result.

At 1202, a first set of images of an effector feature of an end effector coupled to an engagement feature of a robot is obtained, the first set of images including at least a first image of the effector feature from a first perspective and a second image of the effector feature from a second perspective. For example, the first image may be captured by a first camera (such as first camera 126) and the second image may be captured by a second camera (such as second camera 128). The first camera may have a first field of view from a first perspective, and the second camera may have a second field of view from a second perspective. In various embodiments, a plurality of sets of images of the effector feature may be captured. Each set of images of the plurality of sets of images may include at least a first image and a second image of the effector feature in the first coordinate system, and the first image may be different from the second image in each set of images of the plurality of sets of images. A position of the engagement feature in the first coordinate system may be different for each set of images of the plurality of sets of images.

At 1204, an edge is detected in each of the first image and the second image.

At 1206, a coordinate position of the effector feature in a first coordinate system is determined based on the edge of the first image and the edge of the second image. The first coordinate system can be, for example, the robot coordinate system described above. Determining the coordinate position can include determining a coordinate position of the effector feature in a second coordinate system, such as the camera space coordinate system or an absolute coordinate system as described above. This can include, for example, comparing a first perspective position of the effector feature in the first image and a second perspective position of the effector feature in the second image, and triangulating the first perspective position with the second perspective position.

Determining the coordinate position of the effector feature in the first coordinate system may further include sampling the first image and the second image every M lines of pixels, where M is an integer greater than or equal to 2, and detecting at least one edge on each sampled line of the first image and the second image.

In embodiments where a position of the engagement feature in the first coordinate system is different for each set of images of the plurality of sets of images, determining the first coordinate system can include comparing the plurality of sets of images to determine the coordinate position of the effector feature in the first coordinate system. This may include, for example, sampling the first image of each set of images in the plurality of sets of images and the second image of each set of images in the plurality of sets of images every M lines of pixels, where M is an integer greater than or equal to 2, and detecting at least one edge on each sampled line of the plurality of first images and plurality of second images. This may further include determining a coordinate position of the effector feature in a second coordinate system.

At 1208, the robot is calibrated based on the coordinate position of the effector feature in the first coordinate system. This may include, for example, importing the coordinate position of the effector feature in the first coordinate system into a memory accessible to the robot.

The various techniques described herein may be performed by any suitable means capable of performing the operations, such as various hardware and/or software component(s). A hardware component may include circuitry configured to perform one or more techniques described herein.

The methods disclosed herein comprise one or more steps or actions for achieving the described method. The method steps and/or actions may be interchanged with one another without departing from the scope of the claims. In other words, unless a specific order of steps or actions is explicitly specified as being required, the order and/or use of specific steps and/or actions may be modified without departing from the scope of the claims.

Various aspects of systems, apparatuses, computer program products, and methods are described more fully with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of this disclosure to those skilled in the art. Based on the teachings herein, one skilled in the art should appreciate that the scope of this disclosure is intended to cover any aspect and any combination of aspects of the systems, apparatuses, computer program products, and methods disclosed herein. In addition, the scope of the disclosure is not limited to the structure or functionality disclosed herein. Any aspect disclosed herein may be embodied by one or more elements of a claim.

Although particular aspects are described herein, many variations and permutations of these aspects fall within the scope of this disclosure. Although some potential benefits and advantages of aspects of this disclosure may be mentioned, the scope of this disclosure is not limited to particular benefits, advantages, uses, or objectives. Rather, aspects of this disclosure are intended to be broadly applicable to any system, apparatus, computer program product, and method that may employ one or more aspects of this disclosure.

The claims are not limited to the precise configuration and components illustrated herein. Various modifications, changes and variations may be made in the arrangement, operation and details of the methods and apparatus described above without departing from the scope of the claims. Combinations such as “at least one of A, B, or C”; “one or more of A, B, or C”; “at least one of A, B, and C”; “one or more of A, B, and C”; and “A, B, C, or any combination thereof” include any combination of A, B, and/or C, and may include multiples of A, multiples of B, or multiples of C. Specifically, combinations such as “at least one of A, B, or C”; “one or more of A, B, or C”; “at least one of A, B, and C”; “one or more of A, B, and C”; and “A, B, C, or any combination thereof” may be A only, B only, C only, A and B, A and C, B and C, or A and B and C, where any such combinations may contain one or more member or members of A, B, or C. All structural and functional equivalents to the various aspects described throughout this disclosure that are known or later come to be known to those of ordinary skill in the art are expressly incorporated herein by reference and are intended to be encompassed by the claims.

While the foregoing is directed to aspects of the present disclosure, other and further aspects of the disclosure may be devised without departing from the basic scope thereof, and the scope thereof is determined by the claims that follow.

The previous description is provided to enable any person ordinarily skilled in the art to practice the various aspects described herein. Various modifications to these exemplary embodiments presented throughout this disclosure will be readily apparent to those of ordinary skill in the art, and the concepts disclosed herein may be applied to robotic assembly. Thus, the claims are not intended to be limited to the exemplary embodiments presented throughout the disclosure but are to be accorded the full scope consistent with the language claims. All structural and functional equivalents to the elements of the exemplary embodiments described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f), or analogous law in applicable jurisdictions, unless the element is expressly recited using the phrase “means for” or, in the case of a method claim, the element is recited using the phrase “step for.”

What is claimed is:

1. A method comprising:
obtaining a first set of images of an effector feature of an end effector coupled to an engagement feature of a robot, wherein the first set of images includes at least a first image of the effector feature from a first perspective and a second image of the effector feature from a second perspective;
detecting an edge in each of the first image and the second image;
determining a coordinate position of the effector feature in a first coordinate system based on the edge of the first image and the edge of the second image; and
calibrating the robot based on the coordinate position of the effector feature in the first coordinate system.

2. The method of claim 1, wherein the first image is captured by a first camera and the second image is captured by a second camera, wherein the first camera has a first field of view from the first perspective and the second camera has a second field of view at the second perspective.

3. The method of claim 1, wherein determining the coordinate position of the effector feature in a coordinate system further comprises:
determining a coordinate position of the effector feature in a second coordinate system.

4. The method of claim 3, wherein determining the coordinate position of the effector feature in the second coordinate system further comprises:
comparing a first perspective position of the effector feature in the first image and a second perspective position of the effector feature in the second image; and
triangulating the first perspective position with the second perspective position.

5. The method of claim 1, wherein determining the coordinate position of the effector feature in the first coordinate system further comprises:
sampling the first image and the second image every M lines of pixels, wherein M is an integer greater than or equal to 2; and
detecting at least one edge on each sampled line of the first image and the second image.

6. The method of claim 1, further comprising:
capturing a plurality of sets of images of the effector feature.

7. The method of claim 6, wherein each set of images of the plurality of sets of images includes at least a first image and a second image of the effector feature in the first coordinate system, wherein the first image is different from the second image in each set of images of the plurality of sets of images.

8. The method of claim 6, wherein a position of the engagement feature in the first coordinate system is different for each set of images of the plurality of sets of images.

9. The method of claim 8, further comprising:
comparing the plurality of sets of images to determine the coordinate position of the effector feature in the first coordinate system.

10. The method of claim 9, wherein comparing the plurality of sets of images to determine the coordinate position of the effector feature in the first coordinate system further comprises:
determining a coordinate position of the effector feature in a second coordinate system.

11. The method of claim 9, wherein comparing the plurality of sets of images to determine the coordinate position of the effector feature in the first coordinate system further comprises:
sampling the first image of each set of images in the plurality of sets of images and the second image of each set of images in the plurality of sets of images every M lines of pixels, wherein M is an integer greater than or equal to 2; and
detecting at least one edge on each sampled line of the plurality of first images and plurality of second images.

12. The method of claim 1, wherein calibrating the robot based on the coordinate position of the effector feature in the first coordinate system further comprises:
importing the coordinate position of the effector feature in the first coordinate system into a memory accessible to the robot.

13. The method of claim 1, wherein the effector feature is a nozzle tip.

14. An apparatus, comprising:
a robot having an engagement feature;
an end effector coupled to the engagement feature;
a first imaging device configured to capture at least a first image of an effector feature of the end effector from a first perspective;
a second imaging device configured to capture at least a second image of the effector feature from a second perspective; and
a processor coupled to the first imaging device, the second imaging device, and the robot, the processor configured to:
detect an edge in each of the first image and the second image;
determine a coordinate position of the effector feature in a first coordinate system based on the edge of the first image and the edge of the second image; and
calibrate the robot based on the coordinate position of the effector feature in the first coordinate system.

15. The apparatus of claim 14, wherein the first imaging device includes a first camera and the second imaging device includes a second camera, wherein the first camera has a first field of view from the first perspective and the second camera has a second field of view at the second perspective.

16. The apparatus of claim 15, wherein the first field of view overlaps with the second field of view.

17. The apparatus of claim 14, wherein the coordinate position of the end effector in the first coordinate system is determined at least in part by determining a coordinate position of the end effector in a second coordinate system.

18. The apparatus of claim 17, wherein the coordinate position of the end effector in the first coordinate system is determined at least in part by comparing a first perspective position of the end effector in the first image and a second perspective position of the end effector in the second image and triangulating the first perspective position with the second perspective position.

19. The apparatus of claim 14, wherein the coordinate position of the end effector in the first coordinate system is determined at least in part by detecting at least one edge of the end effector in the first image and in the second image.

20. The apparatus of claim 14, wherein the coordinate position of the end effector in the first coordinate system is determined at least in part by sampling the first image and the second image every M lines of pixels, wherein M is an integer greater than or equal to 2 and detecting at least one edge on each sampled line of the first image and the second image.

21. The apparatus of claim 14, wherein the first imaging device is configured to capture a plurality of first images of the end effector from the first perspective and the second imaging device is configured to capture a plurality of second images of the end effector from the second perspective.

22. The apparatus of claim 21, wherein the plurality of first images are different from the plurality of second images.

23. The apparatus of claim 22, wherein a position of the end effector feature in the first coordinate system is different for each image in the plurality of first images and each image in the plurality of second images.

24. The apparatus of claim 23, wherein the coordinate position of the end effector in the first coordinate system is determined at least in part by comparing the plurality of first images and the plurality of second images.

25. The apparatus of claim 24, wherein the coordinate position of the end effector in the first coordinate system is determined at least in part by determining a coordinate position of the end effector in a second coordinate system.

26. The apparatus of claim 25, wherein the plurality of first images corresponds to a first perspective from a first position and the plurality of second images corresponds to a second perspective from a second position.

27. The apparatus of claim 26, wherein coordinate position of the end effector in the first coordinate system is determined at least in part by:
determining a first perspective position of the end effector in the second coordinate system for each image in the plurality of first images;
determining a second perspective position of the end effector in the second coordinate system for each image in the plurality of second images; and
triangulating the plurality of first perspective positions with the plurality of second perspective positions.

28. The apparatus of claim 24, wherein comparing the plurality of first images and the plurality of second images includes detecting at least one edge in each image in the plurality of first images and the plurality of second images.

29. The apparatus of claim 24, wherein comparing the plurality of first images and the plurality of second images includes:
sampling the first image of each set of images in the plurality of sets of images and the second image of each set of images in the plurality of sets of images every M lines of pixels, wherein M is an integer greater than or equal to 2; and
detecting at least one edge on each sampled line of the plurality of first images and plurality of second images.

30. The apparatus of claim 24, further comprising a memory, coupled to the robot, wherein the processor is configured to import the coordinate position of the end effector in the first coordinate system into the memory.

31. The apparatus of claim 21, wherein the end effector feature is a nozzle tip.

32. The apparatus of claim 31, wherein the nozzle tip is configured to dispense a material.

33. The apparatus of claim 32, wherein the material includes curable adhesive.
